(19) United States
(12) Patent Application Publication
(10) Pub. No.: US 2021/0303023 A1
(43) Pub. Date: Sep. 30, 2021

(54) Mounting Assembly

(71) Applicant: Jorge Cardenas, Cody, WY (US)

(72) Inventor: Jorge Cardenas, Cody, WY (US)

(21) Appl. No.: 16/953,790

(22) Filed: Nov. 20, 2020

Related U.S. Application Data
(60) Provisional application No. 62/994,333, filed on Mar. 25, 2020.

(51) Int. Cl. G06F 1/16; G09F 13/04; G06Q 30/02

(52) U.S. Cl. CPC G06F 1/1601; G09F 13/0413; G09F 2013/0445; G06Q 30/0268; G06Q 30/0267

(57) ABSTRACT

The present invention relates generally to a unique mounting assembly, and more specifically a mounting rack or assembly for mounting an advertising screen over a vending machine of other static display. The mounting assembly comprises a support structure and a screen display mounting assembly, which are attached together to hold the advertising screen or monitor in a desired position and at a desired angle. The screen display mounting assembly is repositionable vertically, horizontally and angularly to improve the overall visibility of the advertising screen attached thereto.

### CROSS-REFERENCE TO RELATED APPLICATION

The present application claims priority to, and the benefit of, U.S. Provisional Application No. 62/994,333, which was filed on Mar. 25, 2020 and is incorporated herein by reference in its entirety.

### BACKGROUND

The present invention relates generally to the field of mounting assemblies. More specifically, the present invention relates to a mounting rack or assembly for mounting advertising screens over vending machines and other displays. In fact, the mounting assembly of the present invention is specifically designed to be mounted on the top surface of a vending machine or other display so as to cover a larger market and expose potential consumers to additional product offerings, upcoming events, and the like. The mounting assembly comprises a support structure and a television or monitor mount, which are attached together to hold the advertising screen or monitor in a desired position and at a desired angle. Accordingly, the present specification makes specific reference thereto. However, it should be appreciated that aspects of the present invention are also equally amenable to other like applications, devices and methods of manufacture.

By way of background, digital advertising is one of the most prominent ways to reach a large population of prospective customers in an efficient manner. Generally, advertising is a form of communication used to encourage or persuade an audience to start using (or to continue to use) the items marketed, to attend events, or engage in other conduct or activities which the advertiser or marketer is promoting. Stated differently, advertising refers to an attempt to influence consumer behavior with respect to a commercial offering or other opportunity, such as the purchase of a product or service, attending an event, visiting a destination, and/or other pursuits. Advertisements can be done in a wide range of media including, without limitation, mass media such as newspapers, magazines, television commercials, radio advertisements, outdoor advertising, flyers, direct mail, or news media such as weblogs, websites or text messages. Unfortunately for many advertisers and marketers, mass media-based marketing may end up being regarded as spam and ignored by many prospective purchasers, and as such its impact is then marginalized. Additionally, such mass marketing efforts oftentimes require the marketer or advertiser to possess contact information for members of the intended audience, such as an email address, telephone number, physical mailing address and the like, which may not always be readily available or may be expensive to obtain.

Large billboards are oftentimes used for advertising to display various messages that typically consist of a combination of texts and graphics. The billboards are placed in larger open or public areas, and are designed to be seen by large quantities of people passing by the area where the billboard is located. However, advertisers are often forced to pay exorbitant rates to advertise on television, large billboards, radio, and social media, and it may be difficult for smaller businesses and entrepreneurs to advertise through these types of conventional advertising means. Accordingly, marketers and advertisers are constantly looking for new and more efficient, cost-effective methods of introducing their products and services to prospective customers that may be likely to utilize them.

It is also ideal to advertise in high traffic areas wherein the advertisement has a better chance of being seen and impacting a large number of potential customers. Vending machines, such as those used to dispense snacks, beverages, and consumer products, are typically positioned in high traffic areas and usually have unused space on their top surfaces. Additionally, folks using a vending machine are naturally inclined to look up if there is something positioned on top of or above the vending machine as they are waiting for the vending machine to dispense their purchase. Further, the top surface of such vending machines often remains underutilized.

Therefore, there exists a long felt need in the art for an effective advertising means that can be easily used by advertisers and marketers alike to reach a larger set or group of potential customers. There is also a long felt need in the art for an advertising method that can be easily utilized in a cost-effective manner, and that can be readily adapted to changing market conditions. Additionally, there is a long felt need in the art for a method of advertising in high traffic areas where vending machines are often found, such as in lobbies, transportation terminals, restaurants, and the like, and for an advertising device that utilizes the top or other open surface of the vending machines to display the advertising media. Moreover, there is a long felt need in the art for an advertising device that is cost-effective, can be used by various advertisers, and that is comprised of a repositionable and mountable rack device that can be used to mount a screen for advertising content on a vending machine or other existing display. Finally, there is a long felt need in the art for a mounting assembly that is relatively inexpensive to manufacture and safe and easy to use.

The subject matter disclosed and claimed herein, in one embodiment thereof, comprises a mounting assembly for supporting an advertising screen for advertising events, goods, services, and the like, on an existing vending machine or other display. More specifically, the mounting assembly is comprised of a support structure and an advertising screen mount, wherein the advertising screen mount is removably attached to the support structure via nuts/bolts, or other acceptable fasteners.

The support structure is preferably comprised of two elongated and slotted shelf rails extending longitudinally from the front to the back of the vending machine, two metal bars extending laterally from left to right of the vending machine and connected to the two shelf rails by nuts and bolts (or other suitable fasteners) to fasten the longitudinal rails and lateral bars together. The support structure is further comprised of two generally inverted U-shaped tap-in style shelf brackets with two drilled or punched holes per bracket for nuts and bolts, and two L-shaped brackets with two drilled or punched holes to fasten with two nuts and bolts to the shelf brackets. The shelf brackets may be repositionably attached to the slotted shelf rails, and the L-shaped brackets are attached to the top surface of the shelf brackets. Metal adhesive glue or other bonding agents may also be used to permanently fasten the various components together if the connection is meant to be permanent (e.g., to prevent tampering with the assembly or theft of the advertising screen). The advertising screen mount is attached to the L-brackets of the support structure for attaching an advertising screen to advertise the required content to the individuals using and/or passing by the vending machine.

In this manner, the mounting assembly of the present invention accomplishes all of the forgoing objectives, and provides a relatively easy and cost-effective solution to supporting a digital media advertising display on an existing device, such as a vending machine. The mounting assembly of the present invention is also user friendly inasmuch as it can be easily repositionable, and occupies the otherwise unused space of the top surface of a vending machine. Finally, the improved mounting assembly of the present invention can accommodate various sizes and configurations of digital media advertising displays, as well as various sizes and configurations of vending machines and other static displays.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, relates to a mounting assembly for mounting advertising screens over a static display. More specifically, the mounting assembly is specially designed to be mounted on the top surface of a vending machine so as to provide exposure to a larger market. The mounting assembly of the present invention includes a support structure and a screen mount assembly, which are attached together and to the vending machine to hold the advertising screen in place. Accordingly, the present invention enables advertisers to advertise their events, products, goods and services in high traffic areas in a more cost-effective manner.

The subject matter disclosed and claimed herein, in one embodiment thereof, refers to a mounting assembly for an advertising screen used to advertise events, products, goods, services and the like atop of a vending machine. The advertising mounting assembly is comprised of a support structure and an advertising screen mount. The support structure is preferably comprised of two longitudinal and slotted shelf rails attached to two lateral or cross bars, thereby forming a generally rectangular or square base. The support structure is further comprised of two generally inverted U-shaped tap-in style shelf brackets that may be repositionably attached to the slotted shelf rails, and two L-shaped brackets attached to the top surface of the shelf brackets. The advertising screen mount is attached to the L-brackets of the support structure for attaching an advertising screen.

In yet another embodiment of the present invention, the screen mount and the advertising screen attached thereto are repositionable vertically, horizontally and/or angularly to maximize the visibility of the advertising screen to vending machine patrons and those passing by. Further, each of the support structure and the advertising screen mount are adjustable in size and configuration to accommodate a plurality of different shapes and sizes of vending machines and advertising screens.

In a further embodiment of the present invention, the mountable screen advertises goods, services, events, and products, and provides scannable barcodes and QR codes, links or other information to people in the viewing area. The display screen can be of any size and resolution, and the screen mount is set to fit the display screen size as per the requirements of the installer. The support structure is mounted on the top surface of a vending machine, and can also be adjusted to fit to the dimensions of the top surface of various vending machines, regardless of size and/or configuration.

In a yet still further exemplary embodiment of the presently described invention, a method of using an advertising display in conjunction with a vending machine is disclosed, and includes the initial step of providing a mounting assembly having a support structure and a screen mount assembly, which are attached together and to the vending machine to hold the advertising screen in place. Next, the mounting assembly is attached to a top surface of a vending machine. Then a product that is contained within the vending machine is selected. A message relating to the selected product is then displayed on the advertising display. For example, the message could pertain to nutritional aspects of the selected product or could be a coupon or code for future purchases of the same or other products. After the product is dispensed from the vending machine and the attached message has been displayed, the advertising display could resume playing of the regularly programmed marketing messages and advertisements.

The subject matter disclosed and claimed herein, in one embodiment thereof, provides a method of mounting an advertising screen on a mounting assembly of the present invention. The method includes the initial step of attaching two elongated and slotted shelf rails extending longitudinally from the front to the back of the vending machine to two metal bars extending laterally from left to right of the vending machine to form a generally rectangular base. Then, two generally inverted U-shaped tap-in style shelf brackets are attached to the slotted shelf rails of the base, and generally L-shaped brackets may then be attached to the shelf brackets to complete the construction of the support structure. Then, the advertising screen mount is attached to the L-brackets of the support structure. Finally, an advertising screen for advertising the required content to the individuals using and/or passing by the vending machine is repositionably attached to the advertising screen mount and repositioned (i.e., vertically, horizontally and angularly) to maximize the visibility of the advertising screen to prospective consumers.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side perspective view of one potential embodiment of the support structure of the mounting assembly of the present invention in accordance with the disclosed architecture.

FIG. 2 illustrates a perspective view of one potential embodiment of the screen mount of the mounting assembly of the present invention in accordance with the disclosed architecture.

FIG. 3 illustrates a perspective view of one potential embodiment of the mounting assembly of the present invention in accordance with the disclosed architecture, wherein the mounting assembly is comprised of a support structure and a screen mount.

FIG. 4 illustrates a perspective view of one potential embodiment of the mounting assembly of the present invention in accordance with the disclosed architecture, wherein the mounting assembly is being used to mount a digital media display on an existing vending machine.

FIG. 5 illustrates a block diagram of one potential embodiment of the mounting assembly system of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

As noted above, there is a long felt need in the art for an effective advertising means that can be easily used to reach a larger set or group of potential customers in a cost-effective manner, and that can be readily adapted to changing market conditions. Additionally, there is a long felt need in the art for a method of advertising in high traffic areas, such as in lobbies, transportation terminals, restaurants, and the like, where vending machines are typically located, and that utilizes the top or other open surface of the vending machine to display the advertising media. Moreover, there is a long felt need in the art for an advertising device that is cost-effective, can be used by various advertisers, and is comprised of a repositionable and mountable rack device that can be used to mount a screen for advertising content on a vending machine or other existing display. Finally, there is a long felt need in the art for a mounting assembly that is relatively inexpensive to manufacture and safe and easy to use.

The present invention, in one exemplary embodiment, relates to a new and novel mounting assembly for mounting an advertising screen over a vending machine or similar display. The mounting assembly is specially designed to be mounted on the top surface of a vending machine in a high traffic area, and is comprised of a support structure and an advertising screen mount, which are attached together to hold the advertising screen in place. Accordingly, the present invention enables a user to advertise their goods and services in high traffic areas and in a cost-effective manner.

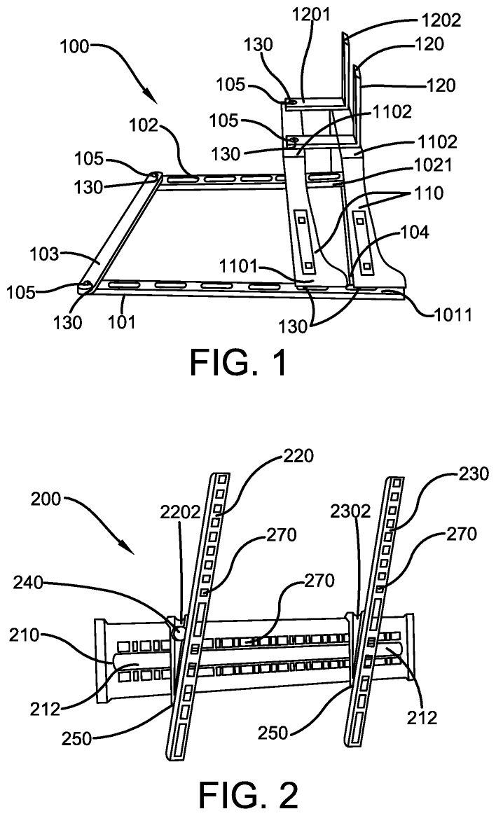

Referring initially to the drawings, FIG. 1 illustrates a side perspective view of one potential embodiment of the support structure 100 of the mounting assembly 300 of the present invention in accordance with the disclosed architecture. More specifically, the mounting assembly 300 is comprised of a support structure 100 for supporting a screen mount assembly 200 on top of a vending machine 400 or other display, wherein an advertising screen 420 is repositionably mounted to the screen mount assembly 200. The support structure 100 can be adjusted in both size and configuration to accommodate a wide range of different styles and sizes of vending machines 400.

The support structure 100 preferably comprises a first longitudinal slotted shelf rail 101, a second longitudinal slotted shelf rail 102, a first cross or lateral metal bar 103, a second cross or lateral metal bar 104, a pair of generally inverted U-shaped tap-in style brackets 110, a pair of two generally L-shaped brackets 120, and a plurality of fasteners (e.g., nuts, bolts, screws, and the like) 130 for fastening the various components of support structure 100 together. More specifically, the first slotted shelf rail 101 and the second slotted shelf rail 102 are in spaced apart and generally parallel relationship to one another and form opposing side panels extending from the front to the rear of the top surface of the vending machine 400. Similarly, the first metal bar 103 and the second metal bar 104 are preferably in spaced apart and generally parallel relationship to one another (and generally perpendicular to shelf rails 101, 102) and serve to attach each of the slotted shelf rails 101, 102 together to form a generally rectangular or square shape base that may, in turn, be mounted to the top surface 410 of the vending machine 400.

Each of the first slotted shelf rail 101 and the second slotted shelf rail 102 may further comprise slots therein for convenient attaching of the first and second metal bars 103, 104 at a specified distance to fit to the top area of the vending machine 400. The spacing between each of the first and second metal bars 103, 104 and the first and second slotted shelf rails 101, 102 may be varied according to the size of the top surface 410 of the vending machine 400. Similarly, the first and second metal bars 103, 104 may further comprise punch holes 105 for mating engagement with the slots on the slotted shelf rails 101, 102, and may be fixed thereto via the fasteners 130. More specifically, the punch holes 105 on the first and second metal bars 103, 104 are aligned with the slots of the slotted rails 101, 102 and are fastened together by nuts and bolts 130 to form a generally square or rectangular shaped structure to fit the top portion of the vending machine 400. Notwithstanding, the fastening mechanism 130 is not limited to nuts and bolts, and other known suitable fasteners may also be used for attaching the various components of the support structure 100. Further, more than two flat metal bars can be used between the two slotted shelf rails 101, 102 as cross bracing and to support and bolt down the support structure 100 to the vending machine 400 to prevent the mounting assembly 300 from being displaced during strong winds and/or other inclement weather, and to prevent tampering and theft.

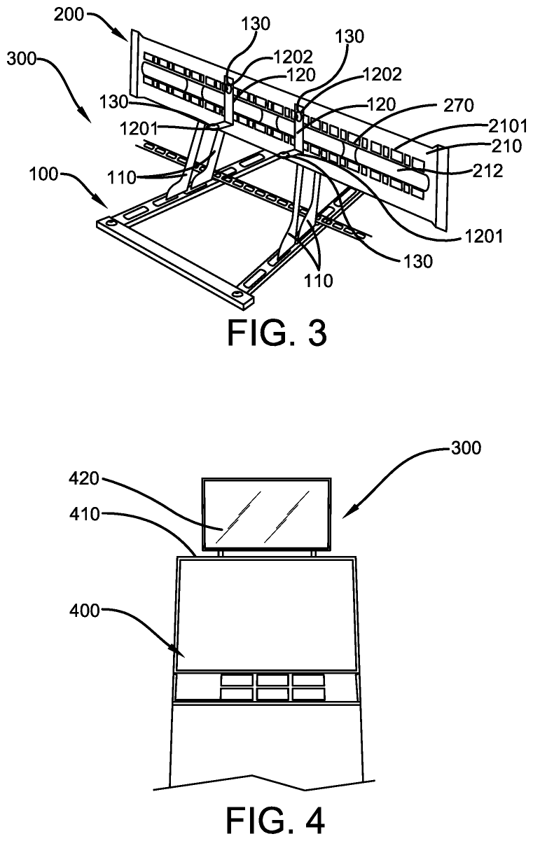

Each of the pair of generally inverted U-shaped tap-in style brackets 110 preferably have two predrilled or punched holes at a first end 1101 and a second end 1102 to provide support and a mating structure or surface for the generally L-shaped brackets 120, as explained more fully below. As best shown in FIGS. 1 and 3, the first tap-in bracket 110 is attached on a front end 1011 and 1021 of each of the slotted shelf rails 101, and 102, and is aligned with the slots of the first slotted shelf rail 101 and the second slotted shelf rail 102, via fasteners 130, such as nuts and bolts. A second of the pair of tap-in brackets 110 is similarly attached to each of the slotted shelf rails 101, 102, in spaced apart and generally parallel relationship to the first of the pair of tap-in brackets 110. The tap-in style shelf brackets 110 may also be fastened permanently to the base using a metal adhesive glue or other bonding materials, such as double sided tape, silicone-based adhesives and other materials.

The generally L-shaped brackets 120 are attached in a generally parallel fashion to the second end 1102 of the tap-in brackets 110 using fasteners 130, such as nuts and bolts. More specifically, a punched hole 105 on the L-shaped bracket 120 is aligned with the hole on the second end 1102 of the tap-in brackets 110 and connected thereto with fasteners 130. Nonetheless, other fastening mechanisms may also be used to attach the L-shaped brackets 120 to the bent or angled tap-in style brackets 110. The vertical portion of the L-shaped brackets 120 further include punched holes or openings 105 to attach a screen mounting assembly 200 thereto, as explained more fully below. Each of the components of the support structure 100, such as the slotted shelf rails 101, 102, the metal cross bars 103, 104, the tap-in style brackets 110, and generally L-shaped brackets 120 are made up of a durable material, such as stainless steel, iron, aluminum, plastic or the like. Further, where a metal material is utilized, the same may be coated with a paint and/or anti-corrosive coating to prevent rust from forming and to prolong the useful life of the support structure, particularly if the same will be positioned outdoors and exposed to the elements, such as wind, rain, sleet, snow and the like.

FIG. 2 illustrates a perspective view of one potential embodiment of the screen mount 200 of the mounting assembly 100 of the present invention in accordance with the disclosed architecture. The screen mount 200 is preferably comprised of a mounting bracket 210, a first mounting arm 220, a second mounting arm 230, a tilting knob 240, and a secure locking mechanism 250. More specifically, the screen mounting apparatus 200 includes a mounting bracket 210 for mounting a display or advertising screen 420 to the apparatus 200 which is in turn attached to the vending machine 400 via the support structure 100. The mounting bracket 210 is in the form of an elongated channel having a backplate and an elongated slot at the center of the backplate. The mounting bracket 210 includes a plurality of slots 270 along the length of the backplate, and near the longitudinal side walls. The plurality of slots 270 are provided so that fasteners 130 (e.g., screws, nuts and bolts, etc.) can be placed through the slots 270 to mount or attach the mounting bracket 210 to the generally L-shaped brackets 120 of the support structure 100 and to the arms 220 and 230, for mounting the advertising screen panel on the top surface 410 of the vending machine 400.

More particularly, the first mounting arm 220 and the second mounting arm 230 are generally elongated structures having a plurality of slots 270 and have a first member 2202 and a second member 2302 respectively at the center of the arms 220, 230. The first and second members 2202, 2302 may be attached on any of the ends of the arms as well, and are used for attaching the arms 220, 230 to the mounting bracket 210. The plurality of slots 270 on the first and second mounting arms 220, 230 are used for mounting an advertising screen 420 to the screen mount assembly 200, and to adjust the size of the screen mount assembly 200 to accommodate the size and configuration of the advertising screen 420 by sliding the arms 220, 230 along the mounting bracket 210. For example, to accommodate a larger sized advertising screen 420, the distance between the arms 220, 230 is increased and then locked in place via the securing mechanism 250. Similarly, to accommodate a smaller sized advertising screen 420, the distance between the arms 220, 230 is decreased (e.g., by moving said arms 220, 230 closer to one another) and then locked in place via the securing mechanism 250. Each of the arms 220, 230 are easily slidable on the elongated slots 212 of the mounting bracket 210.

In a preferred embodiment of the present invention, the first member 2202 further comprises a tilting knob 240 to enable tilting of the mechanism for the screen mounting assembly 200. The tilting knob 240 enables the arms 220, 230 to tilt forward and/or backward the members 2202, 2302. More specifically, the members 2202, 2302 expand or retract to tilt forward and/or backward respectively based on the settings of the tilting knob 240. As an example, rotating the titling knob 240 in a clockwise direction may cause the top of arms 220, 230 to tilt towards a forward orientation (i.e., away from the mounting bracket 210), and rotating the tilting knob 240 in a counter clockwise direction may cause the arms 220, 230 to tilt towards a backward orientation (i.e., in the direction of the mounting bracket 210). Notwithstanding, the tilting mechanism 240 is not limited to a knob structure, and other known tilting mechanisms, such as button, lever, etc., may also be used. Additionally, the degree of rotation of the tilting knob 240 changes the degree of tilting of the arms 220, 230 in the forward or the backward direction. The amount that the assembly may tilt is preferably between 0 (i.e., generally vertical) and 135 degrees (from the vertical). Stated differently, the arms may tilt from the substantially vertical position to a position leaning forward over the front of the vending machine 200 so that a vending machine customer or others passing by can more easily see the advertising screen 420 attached thereto. More preferably, the tilt of the display will be between 0 and 90 degrees, and even more preferably between 45 and 90 degrees.

The first mounting arm 220 and the second mounting arm 230 are attached to the mounting bracket 210 by aligning the first member 2202 and the second member 2302 over the elongated slots 212 and the smaller slots 270. Once in the desired location, the first and second members 2202, 2302 are secured in place using a locking mechanism 250. The locking mechanism 250 may be a clip or other kinds of fastening mechanism for securely clipping the arms 220, 230 to the mounting bracket 210. The members 2202 and 2302 may be attached using nuts and bolts as well.

FIG. 3 illustrates a perspective view of one potential embodiment of the mounting assembly 300 of the present invention in accordance with the disclosed architecture, wherein the mounting assembly 300 is comprised of the above referenced support structure 100 and advertising screen mount 200. More specifically, the generally L-shaped brackets 120 of the support structure 100 have a first end 1201 and a second end 1202, in which the first end 1201 is attached to the tap-in style bracket 110 using nuts and bolts or other fastening mechanisms 130, such as screws, pivot pins or etc. The second end 1202 of the generally L-shaped bracket 120 has a vertical portion and a punch hole 105 therein which is aligned with the smaller slots 270 and the elongated slot 212 of the back portion 2101 of the mounting bracket 210, and is fastened using nuts and bolts or other fastening mechanisms 130. The fastening mechanism 130 secures the screen mount assembly 200 to the support structure 100, thereby providing a firm structure for mounting an advertising screen 420 on the top surface 410 of a vending machine 400. More specifically, the advertising screen 420 is mounted on the screen mount assembly 200 towards the front portion 2102 of the mounting bracket 210. The mounting assembly 300 is used for mounting an advertising or display screen 420 over a vending machine 400 in a high traffic area.

FIG. 4 illustrates a perspective view of one potential embodiment of the mounting assembly 300 of the present invention in accordance with the disclosed architecture, wherein the mounting assembly 300 is being used to mount a digital media display 420 on an existing vending machine 400. The vending machine 400 is provided for storing and dispensing food items, beverages and other consumer goods, and is typically located in high traffic areas. The top surface 410 of the vending machine 400 is rarely utilized, but may now be used in conjunction with the mounting assembly 300 of the present invention to repositionably display an advertising screen 420. The mounting assembly 300 of the present invention enables advertisers to reach a larger market by providing a convenient outlet for displaying the media or other messaging in high traffic areas. The messaging for the display 420 may be provided via an endless loop recording stored in the display device which is changed periodically by the installer or marketer. Alternatively, the display may be wirelessly connected to a remote server, which provides advertising messaging to the vending machine based on a particular marketing theme or program that is currently being run by the advertiser or sponsor.

In differing embodiments, the advertising screen 420 may have different resolutions including, but not limited to, 1080p and 4k. The screen panel 420 advertises goods/services in a space 410 on the vending machine 400 by utilizing previously wasted space. The advertising screen 420 may display links, bar codes, QR codes etc., wherein the user can point their smartphone or other smart device towards the same to obtain information through the code, such as by redirecting the user to a particular URL. In one embodiment of the present invention, the advertising screen 420 would be visible through a mobile application using a phone and augmented reality technology to display ads and other information, such as properties of the products inside the vending machine 400, and in an example where food is the product offering the additional information may include calories, prices and ingredients. In one embodiment, the display 420 can also be used to promote products that are complimentary to the products provided in the vending machine 400, thereby adding additional point of sale information for prospective customers. The display 420 can be generalized, that is providing information about all the products in the vending machine 400, or can be programed to promote certain products. In addition, the display 420 can also be linked to the vending machine's selection pad, such that when a customer makes a product selection, the display changes to promote uses of the particular product selected or provide additional information to the purchaser about the product.

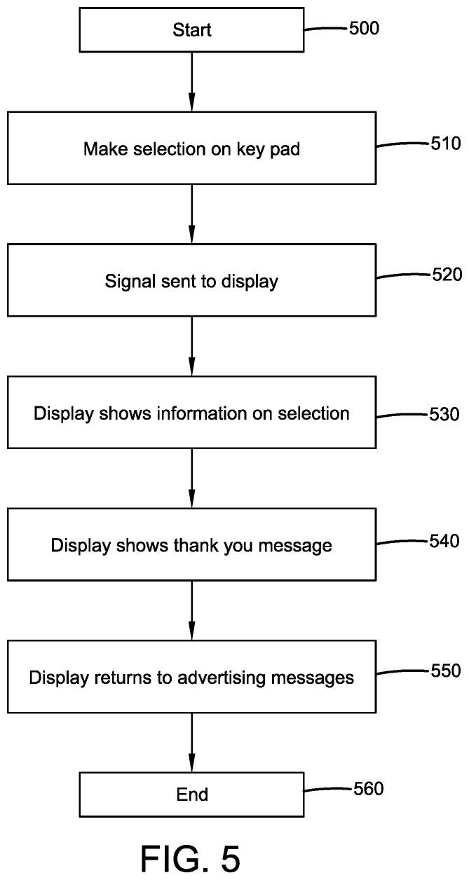

FIG. 5 illustrates a block diagram of one potential embodiment of the mounting assembly system of the present invention in accordance with the disclosed architecture. More specifically, the system process starts at step 500. Then, at step 510, a customer makes a selection on a key pad or via a smart device, which causes a signal to be sent to the display at step 520. The signal may be passed wirelessly, or the display may be hard wired to the vending machine to receive the signal. At step 530, the signal is processed by a processor and a message relating to the product selected is shown on the display. Next, a thank you message is displayed to the customer on the display at step 540, and then the system reverts to the advertising program that is being run on the display at step 550. At step 560, the system terminates or returns to step 500.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “mount”, “mounting rack”, “mount assembly” and “mounting rack assembly” are interchangeable and refer to the mounting assembly of the present invention.

Notwithstanding the forgoing, the mounting assembly of the present invention and its various components can be of any suitable size and configuration as is known in the art without affecting the overall concept of the invention, provided that it accomplishes the above stated objectives. One of ordinary skill in the art will appreciate that the size, configuration and material of mounting rack assembly and its various components as shown in the FIGS. are for illustrative purposes only, and that many other sizes of the mounting rack assembly are well within the scope of the present disclosure. Although the dimensions of the mounting rack assembly and its various components are important design parameters for user convenience, the mounting rack assembly and its various components may be of any size that ensures optimal performance during use and/or that suits user need and/or preference.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A mounting assembly for an advertising display comprising:
a first rail, a second rail, a first bar and a second bar, wherein the first and second rails are spaced apart and generally parallel to one other and perpendicular to each of the first and second bars, and further wherein each of the first and second rails is attached to each of the first and second bars to form a base;
a first bracket and a second bracket, wherein each of the first and second brackets are repositionably attached to each of the first and second rails and extend outwardly from the base;
a first support bracket and a second support bracket, wherein each of the first and second support brackets are generally L-shaped and attached to each of the first and second brackets; and
a screen mounting assembly.

2. The mounting assembly for an advertising display of claim 1, wherein each of the first and second rails are provided with a plurality of equally spaced slots therein for receiving the first and second bars and the first and second brackets.

3. The mounting assembly for an advertising display of claim 1, wherein first and second bars are mounted on a top of each of the first and second rails and secured thereto with a mechanical fastener.

4. The mounting assembly for an advertising display of claim 1, wherein the screen mounting assembly is secured to each of the first and second support brackets.

5. The mounting assembly for an advertising display of claim 1, wherein the screen mounting assembly may be angled between 0 and 135 degrees from a vertical axis.

6. The mounting assembly for an advertising display of claim 1, wherein one of the first and second support brackets may be angled between 0 and 135 degrees from a vertical axis.

7. The mounting assembly for an advertising display of claim 1, wherein the screen mounting assembly further comprises a tilting control to adjust an angle of the advertising display between 0 and 135 degrees from a vertical axis.

8. The mounting assembly for an advertising display of claim 1, wherein the screen mounting assembly further comprises a locking mechanism for securing the advertising display in desired position.

9. The mounting assembly for an advertising display of claim 1 further comprising the advertising display mounted to the screen mounting assembly.

10. A combination vending machine and advertising display comprising:
an advertising display;
a vending machine having a top surface;
a mounting assembly for supporting the advertising display on the top surface of the vending machine, wherein the mounting assembly comprises:
a first rail, a second rail, a first bar and a second bar, wherein the first and second rails are spaced apart and generally parallel to one other and perpendicular to each of the first and second bars, and further wherein each of the first and second rails is attached to each of the first and second bars to form a base;
a first bracket and a second bracket, wherein each of the first and second brackets are repositionably attached to each of the first and second rails and extend outwardly from the base;
a first support bracket and a second support bracket, wherein each of the first and second support brackets are generally L-shaped and attached to each of the first and second brackets; and
a screen mounting assembly.

11. The combination vending machine and advertising display of claim 10, wherein the advertising display is repositionable vertically, horizontally and angularly relative to the top surface of the vending machine.

12. The combination vending machine and advertising display of claim 11, wherein the screen mounting assembly is mounted to each of the first and second support brackets.

13. The combination vending machine and advertising display of claim 11, wherein the advertising display is wirelessly connected to a remote server to receive an advertising message.

14. The combination vending machine and advertising display of claim 11, wherein the advertising display is in communication with the vending machine to receive an advertising message from the vending machine.

15. The combination vending machine and advertising display of claim 14, wherein the advertising message relates to a product contained within the vending machine.

16. The combination vending machine and advertising display of claim 10, wherein the screen mounting assembly comprises a tilting control to adjust an angle of the advertising display between 0 and 135 degrees relative to a vertical axis.

17. A method of using an advertising display and mounting system comprising the steps of:
providing a mounting assembly for supporting an advertising display, the advertising display showing a marketing message;
attaching the mounting assembly to a top surface of a vending machine;
selecting a product contained within the vending machine;
displaying a message relating to the product on the advertising display; and
resuming display of the marketing message.

18. The method of using an advertising display and mounting system of claim 17, wherein the mounting assembly comprises:
a first rail, a second rail, a first cross bar and a second cross bar, wherein each of the first and second rails are placed in perpendicular relationship to the first and second cross bars and the first and second cross bars overlap the first and second rails and are secured to the first and second rails via a fastener;
a first bracket and a second bracket, wherein each of the first and second brackets are attached to the each of the first and second rails;
first and second L shaped support brackets each connected to the first and second brackets; and
a screen mounting assembly.

19. The method of using an advertising display and mounting system of claim 18, wherein the screen mounting assembly comprises a mounting bracket, a first arm, a second arm, a tilting mechanism and a locking mechanism.

20. The method of using an advertising display and mounting system of claim 17, wherein the advertising display is connected either to the vending machine or wirelessly to a remote server to receive the marketing message.
